(19) United States
(12) Patent Application Publication
(10) Pub. No.: US 2018/0363690 A1
(43) Pub. Date: Dec. 20, 2018

(54) BONDED ASSEMBLY AND BONDING METHOD

(71) Applicant: COLD PAD, Paris (FR)

(72) Inventor: Jean-Philippe COURT, Paris (FR)

(21) Appl. No.: 15/778,637

(22) PCT Filed: Oct. 26, 2016
(86) PCT No.: PCT/FR2016/052787

§ 371 Date: May 24, 2018

(30) Foreign Application Priority Data
Nov. 26, 2015 (FR) 15 61395

(51) Int. Cl. F16B 11/00; C09J 5/00

(52) U.S. Cl. CPC F16B 11/006; C09J 5/00

(57) ABSTRACT

A bonded assembly that includes a substrate (102), a connector (101, 201) including a bonding surface arranged with a gap to the substrate (102), a support zone surrounding the bonding surface, at least one gasket (202) compressed between the substrate and the support zone, the gasket (202), the connector (101, 201) and the substrate (102) delimiting a sealed volume (209), a recessed overflow groove (208) formed between the bonding surface and the support zone and forming part of the sealed volume (209) and a hardened adhesive (107) at least partially occupying the sealed volume, the adhesive holding the connector on the substrate via the bonding surface.

The present invention relates to techniques for creating bonded assemblies and, more particularly, such assemblies in environments which are said to be very harsh toward them.

It finds applications in very varied fields among which mention may be made of the connecting of an element to a substrate, notably to a substrate on which no fastening element was initially provided or alternatively the reinforcing of structures that need to be rendered stronger in order to repair structural defects or prevent them from arising.

The assembling of a metal element on a metal substrate is often performed using welding. That technique requires a great increase in temperature, which spreads because of the thermal conductivity of the metal substrate. It is sometimes proscribed because of environmental incompatibilities, for example if there is a flammable material in the vicinity of the assembly zone (e.g. on a gas transporter ship). Its use may also be problematic if the structure comprising the substrate has paintwork or coatings which degrade at high temperature, because the welding of the element then entails the need to reapply the paint or coating, something which may be lengthy and costly.

For these reasons, welding techniques present serious problems on board offshore platforms or ships or pipes that transport hydrocarbons or other flammable substances. They are often employed in such situations, but have the disadvantage of requiring operation to be shut down for a fairly lengthy period and also of requiring measures that are sometimes restrictive in order to ensure the required level of safety. Welding techniques are also extremely difficult to perform under water or in tidal regions.

Furthermore, welding is impossible with certain materials such as glass. Usually, with a glazed surface, openings are provided at the time of manufacture of the glazed surfaces so that mechanical components can be attached thereto, but in the case of toughened glass and because of the manufacturing techniques, it is impossible to add an opening (for a fastener) after manufacture. Furthermore, these openings locally accentuate the stresses in their vicinity (typically by a factor of around 3) and thus weaken the glazed surfaces.

Another solution is to bond the element to the substrate using a thermosetting or thermoplastic adhesive. One difficulty is then to guarantee that the desired properties of the adhesive are obtained. In general, suppliers characterize the properties of adhesives under conditions that are very well controlled, notably in terms of temperature, relative humidity, etc. Now, these conditions are not necessarily all present in practice, particularly in the case of interventions in a marine environment. Furthermore, it is extremely difficult to guarantee the long-term hold of the adhesive if the environment is relatively harsh, and this is also unfavorable to interventions in a marine environment.

A structure is sometimes reinforced by applying a reinforcer made of a metallic or composite material to the structure. Nevertheless, problem similar to those mentioned hereinabove for the case of the bonding of an element to a substrate arise. In the case of a reinforcer of metallic type, the latter is connected to the structure using an adhesive, such as a resin. Composite material usually contains a resin which notably acts as an adhesive, and it is difficult to guarantee correct behavior thereof if it is applied under poorly controlled conditions. The composite material may degrade over the course of time if the environment of the reinforcer is harsh. The same is true of the adhesive in the case of a metallic reinforcer. The reinforcement conferred upon the structure is therefore not a lasting reinforcement.

The present invention seeks to set aside some of the limitations of the aforementioned techniques and notably seeks to provide a bonded assembly which is reliable and lasting, even if the environment is potentially harsh.

The present invention therefore relates to a bonded assembly, said assembly comprising:
a substrate;
a connector comprising:
   a bonding surface arranged with a gap to the substrate;
   a support zone surrounding said bonding surface;
at least one gasket compressed between the substrate and the support zone, said gasket, the connector and the substrate delimiting a sealed volume;
a recessed overflow groove formed between the bonding surface and the support zone and forming part of the sealed volume; and
a hardened adhesive at least partially occupying said sealed volume, the adhesive holding the connector on the substrate via the bonding surface.

The adhesive may be under tension and this makes it possible to keep the gasket in a state of compression.

The presence of the compressed gasket between the substrate and the support zone allows the adhesive (present between the bonding surface and the substrate) to be protected from external attack.

Furthermore, the overflow groove allows surplus adhesive to be collected, the adhesive generally in practice being introduced in excess.

The groove may be formed directly on the bonding surface (e.g. at the periphery thereof), but may also be of any shape (e.g. set-back space for storing surplus adhesive, space of a thickness greater than the gap between the bonding surface and the substrate).

Furthermore, the connector may comprise a first element and a second element, the second element being secured to the first element.

It is thus easy to check the state of the adhesive by unscrewing the component securing the first element and the second element to one another (it being possible for this component to be the first element and/or the second element).

The first element and the second element may be secured together by screw-fastening, bonding, welding or any other means of mechanical connection.

In one embodiment, the connector may comprise an interface for attaching an external element and in which the interface has a mechanical breaking strength that is lower than a mechanical breaking strength of the hardened adhesive.

Here, the assembly may easily serve for attaching a more complex structure, it being possible for this more complex structure to be attached without welding or without drillings.

This mechanical strength may be a pull-out strength, a shear strength and/or a translational strength.

Thus, if excessive force is applied to the assembly, the latter may be designed so that it is the mechanical connection that yields before the connection achieved using the adhesive. This is because it is often simpler to replace the mechanical connection than to achieve a new bond using adhesive (which may require special conditions of application (e.g. conditions of relative humidity) and may take several hours (curing time)).

In the case of an assembly using a bolt tightened to a controlled torque, the slippage of the friction surfaces may be considered to be the threshold value for the weak-link element concerned.

Advantageously, the interface may be a threaded rod or a hollow threaded rod or a tapping or a drilled plate or a cable, or a loop, or a ring.

In one particular embodiment, the connector may be partially coated in a flexible coating, the bonding surface not being coated.

This coating may make it possible to absorb impacts on certain parts of the connector which are exposed to the external environment.

Moreover, the at least one gasket may be formed by said flexible coating.

Thus, there is no need, in this embodiment, to specifically provide a gasket, the latter being created as a result of the presence of the flexible coating.

In one particular embodiment, the connector may comprise a one-piece component comprising the bonding surface and the support zone, the overflow groove being formed in the one-piece component.

The invention also relates to a method for bonding a connector to a substrate, comprising:
bringing an installation device into contact with the substrate in such a way that the installation device and the substrate delimit a hermetic space, said connector being installed in said hermetic space and arranged with a gap to the substrate;
reducing the pressure within said hermetic space;
moving the connector toward the substrate to compress an adhesive between the substrate and the connector.

The act of creating a depression in the installation device allows it to be kept in place during the operations of moving the connector and thus ensures that it is correctly positioned.

Furthermore, the depression may make it possible to help with or even initiate the moving of the connector using a difference in force.

Finally, the depression makes it possible to reduce the absolute/relative moisture level in the hermetic space.

In one embodiment, the reduction in pressure may lead to a pressure within said hermetic space that is below a saturation vapor pressure of water.

The reduction in pressure within the hermetic space to below a saturation vapor pressure of water makes it possible to reduce the moisture level considerably, and to vaporize the liquid water present on the internal walls of the hermetic space.

Thus, before the connector is moved toward the substrate, the moisture conditions can be checked and it is possible to ensure that the conditions for the bonding are optimal.

Furthermore, the method may involve:
increasing the pressure within said hermetic space;
following said increase, removing the installation device from the substrate.

Thus, the installation device may simply be removed without any cumbersome procedure.

For example, a movement of at least one surface of the installation device under the effect of a pressure difference may contribute to the moving of the connector.

The movement of the surface of the installation device may be a deformation of a wall or a translational movement of a wall, for example.

Thus, through the simple reduction in pressure mentioned hereinabove, it is possible to apply a force that contributes to the moving of the connector. That being so, no other complex device (e.g. pistons or the like) is needed in order, at the appropriate moment, to move the connector toward the substrate.

In addition or as an alternative, a time difference between the reduction in pressure and the moving of the connector may be longer than 20 s.

Thus, the connector is not set in motion right at the start of the reduction in pressure and it is possible to wait until the conditions relating to the moisture or to the presence of liquid water are suitable.

It has been found that this value of 20 seconds yields very good conditions.

The reduction in pressure may induce an absolute pressure within said hermetic space of below 900 mbar.

Thus, this pressure allows the installation device to be kept in place, against the substrate. Furthermore, the creation of a depression makes it possible to verify that sealing is achieved at the contact between the substrate and the installation device: a sealing gasket positioned in the region of this contact may assist with achieving this vacuum. Of course, another pressure close to vacuum pressure (e.g. 150 mbar or 50 mbar) may also serve as a threshold value.

Advantageously, the moving of the connector may be performed if at least one condition relating to a moisture content inside the hermetic volume is met.

Thus, if the moisture content of the hermetic volume is too high, it is possible to wait until this moisture content is acceptable. Of course, this waiting period may have a maximum value (e.g. “if the moisture content is not satisfactory, the waiting time is 5 min at most”).

In one particular embodiment, the method may further comprise a braking of the connector during the movement toward the substrate.

This braking makes it possible to prevent the connector from moving too quickly toward the substrate, which movement could result in an impact and potentially result in damage to the substrate or damage to the homogeneity of the adhesive.

The method may further comprise injecting the adhesive after the reduction in pressure.

Thus, there is no need to pre-place the adhesive on the connector. Thus, during operations under extreme conditions (e.g. underwater installation), it is possible to avoid exposing the adhesive to the harsh environment.

For example, the method may involve moving the connector toward the substrate before injection.

Thus, it is possible to move the connector to a few centimeters or a few millimeters away from the substrate (depending on the rheology of the adhesive), thus allowing controlled spreading of the adhesive between the substrate and the connector.

In one embodiment, the method may further comprise:
emptying a liquid contained in said hermetic space;
rinsing said hermetic space;
dehydrating said hermetic space.

This embodiment is advantageous in an underwater environment. Rinsing makes it possible for example to eliminate salinity. This rinsing may be performed using a particular solvent or using distilled water.

It is also possible to introduce a particular gas to carry out the dehydration (e.g. hot gas, nitrogen). Dehydration achieved by effecting a reduction in pressure is also possible.

Furthermore, the method may comprise:
keeping the connector in compression on the substrate while the adhesive hardens.

This compression of the adhesive has a beneficial effect on the hold of the connector.

In one embodiment, the method further comprises:
after the adhesive has hardened, applying a test force to the connector.

This test makes it possible to check that the bonding is sufficiently effective and meets the requirements.

The method may further comprise:
maintaining said connector at a temperature below 0° C., the adhesive being applied to said connector during the temperature-maintaining period,
warming said adhesive before a hardening of said adhesive.

The warming may be performed using a heating system during implementation of the method. Thus, it is possible to apply the adhesive upstream of the bonding process and avoid this adhesive having to be applied on site, at the time of bonding: in this way, the quality of the application of the adhesive can be better controlled.

Of course, the bonding method may be partially or fully automatic.

Further features and advantages of the invention will become further apparent from reading the following description. This description is purely illustrative and is to be read in conjunction with the attached drawings, in which:

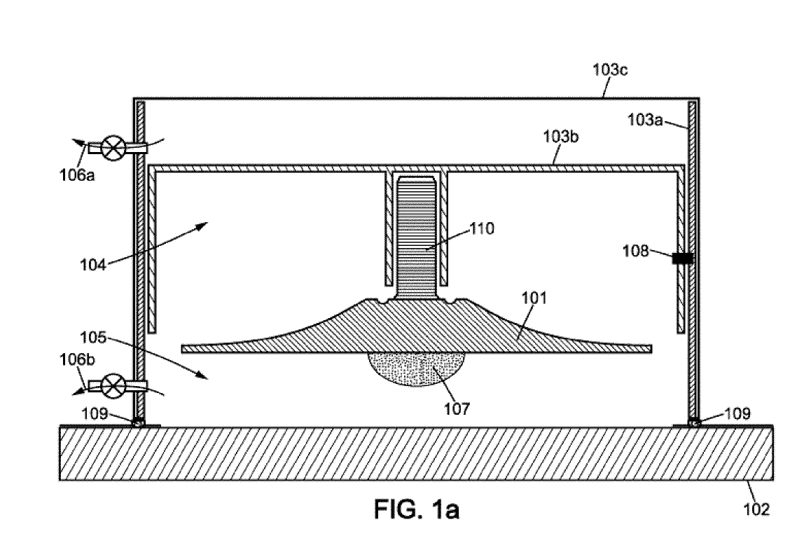

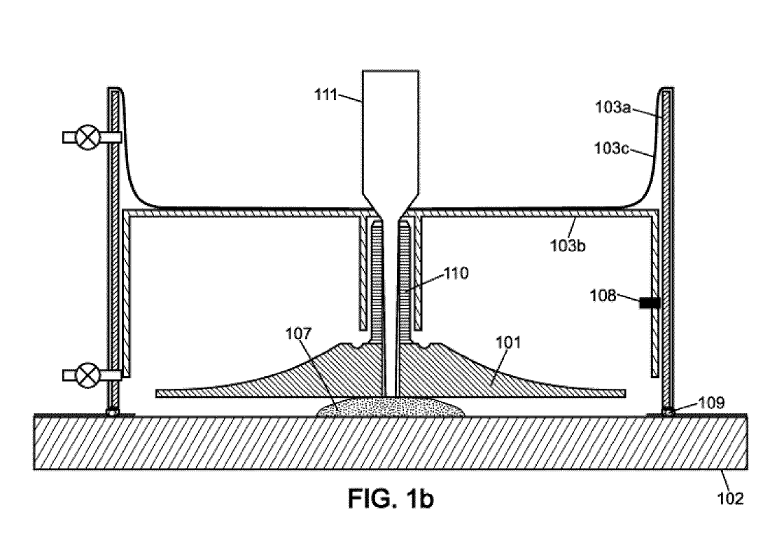

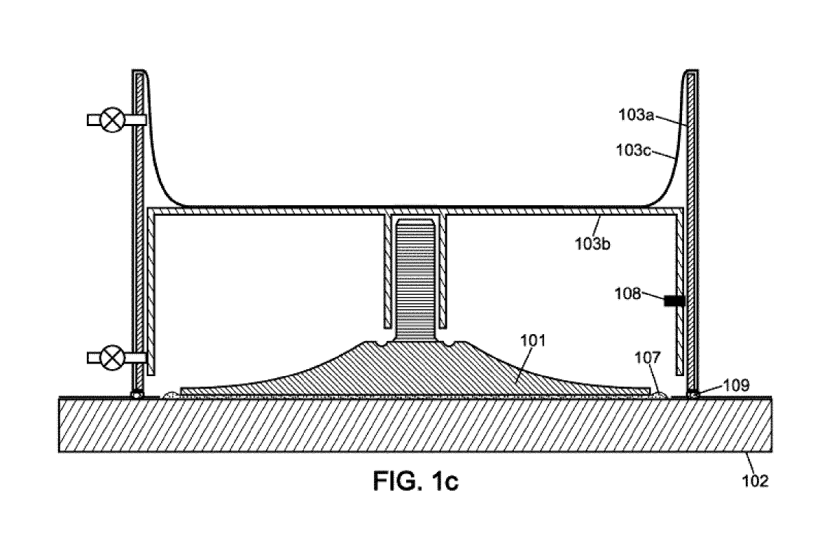

FIGS. 1a to 1c illustrate possible embodiments regarding the method for bonding the final assembly;

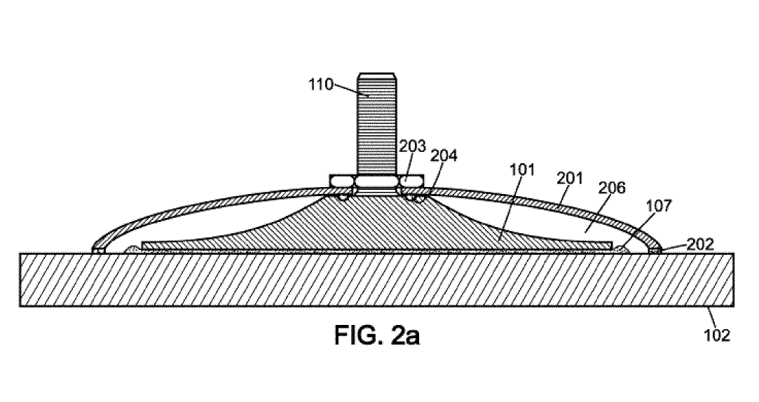

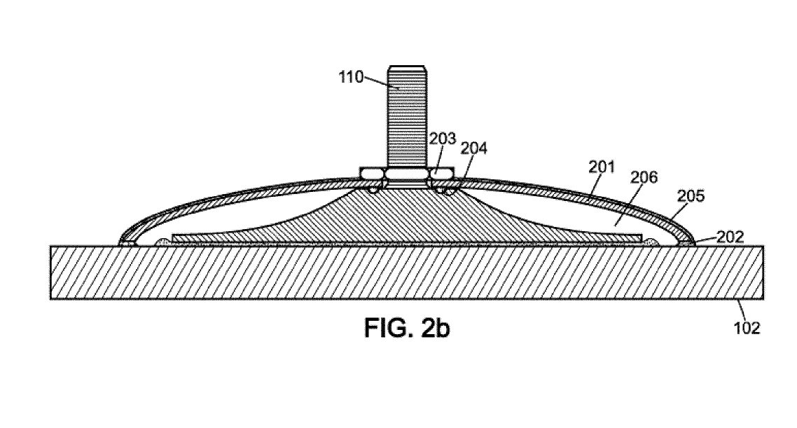

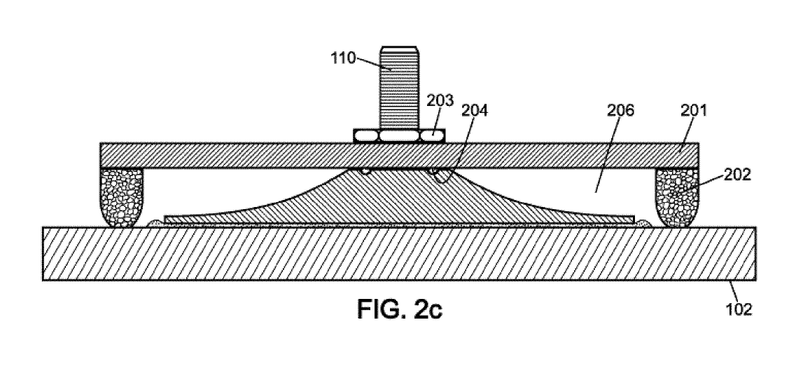

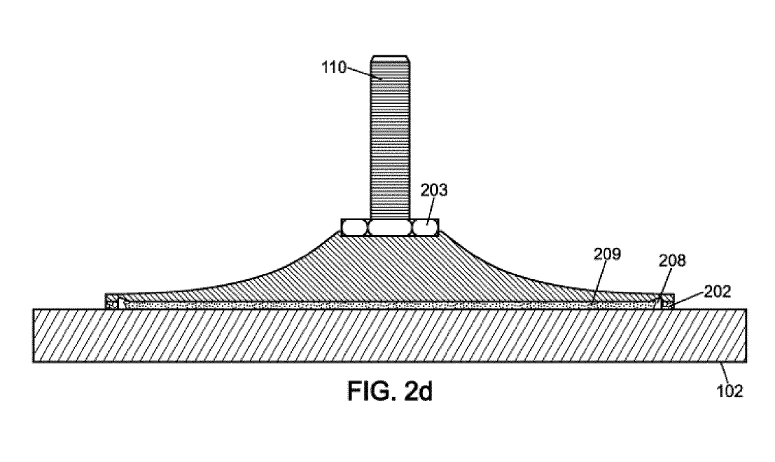

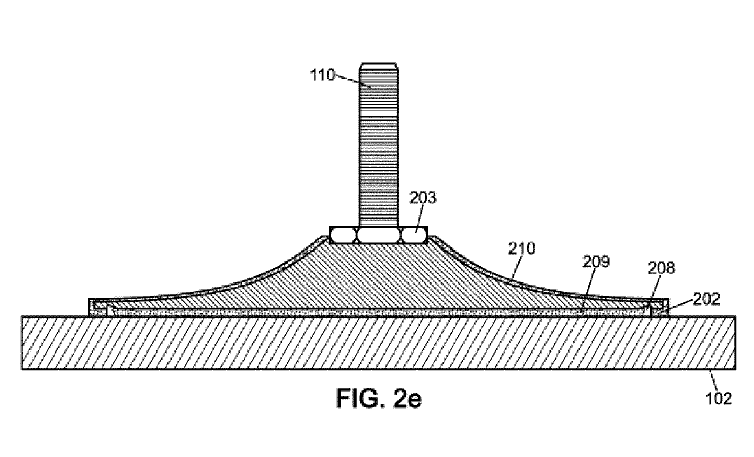

FIGS. 2a to 2e illustrate schematic views of embodiments of a bonded assembly according to the invention.

FIG. 1a illustrates one possible embodiment regarding the method for bonding the final assembly.

In this embodiment, an installation device 103a to 103c is installed in contact with the substrate 102.

The installation device comprises a wall 103a. At one end of this wall there may be a gasket 109 (for example an O-ring seal), the purpose of which is to form a sealed contact interface with the substrate 102 when the installation device is pressed against the substrate 102.

The installation device of FIG. 1a also comprises a wall 103c fixed to the wall 103a. Advantageously, this wall 103c is deformable/flexible and sealed. It is also possible for this wall to be translationally movable or to be fixed. Thus, the installation device, once installed on the substrate, defines a hermetic space 104.

Inside this hermetic space 104, it is possible to position (prior to installing the installation device against the substrate) a mobile component 103b intended to accept the connector 101 that is to be bonded to the substrate 102. For example, the mobile component 103b may be mobile in a direction parallel to the walls of the element 103a (i.e. in the vertical direction according to the embodiment shown in FIG. 1a) so that the connector 101 can be moved into contact with the substrate 102. The connector 101 may be attached temporarily to the mobile component 103b, for example by screwing onto the screw 110 (fixed to or forming part of the connector 101). Advantageously, it is possible to rotate the mobile component 103b about an axis parallel to the screw 110 when the mobile component 103b is installed in the installation device 103a, 103b (and in that way it is possible easily to disconnect the mobile component 103b from the connector 101 after bonding): for example, it is therefore possible for the wall 103a to have a cylindrical shape and for the mobile component 103b to have a shape that complements this cylindrical shape (at least partially) so as to allow it to turn.

The connection of the connector in the installation device may also be a mechanical connection referred to as “weak”, which means to say that this connection breaks at a force of a few newtons. This “weak” connection makes it possible to hold the connector in the installation device. This weak connection may for example be a magnetic connection or a U-shaped clip rubbing against the threaded rod 110.

A translation blocking element, for example a catch 108, when engaged, may limit the mobility of the mobile component 103b notably in the direction parallel to the walls of the element 103a.

Advantageously, the mobile component 103b may be in contact with the wall 103a in such a way that this contact is sealed (e.g. via the use of a flexible gasket for example): if a depression is created in the installation device, between the substrate 102 and the mobile component 103b (in the space 104), this depression does not spread into the installation device, between the flexible component 103c and the mobile component 103b (in this embodiment, it is possible for the wall 103c not to be movable or deformable, for example, or simply not to be present).

The installation device may also comprise one or more valves able to allow reduction in pressure within the installation device when it is positioned on the substrate 102. For example, in FIG. 1a, a first valve allows fluid (e.g. air, arrow 106a) in the upper zone of the installation device to be extracted. This first valve is advantageous, notably in the hypothetical situation in which there is no physical contact between the wall 103a and the mobile component 103b or if this contact is not sealed contact. Specifically, the extraction of the fluid then makes it possible to reduce the pressure throughout the hermetic space of the installation device.

A second valve may also allow the extraction of fluid (e.g. air, arrow 106b) from the bottom zone of the installation device (i.e. between the mobile component 103b and the substrate 102). This second valve is advantageous notably in the hypothetical situation in which there is sealed physical contact between the wall 103a and the mobile component 103b. This is because extracting the fluid then makes it possible to reduce the pressure in the space of the installation device comprised between the mobile component 103b and the substrate without reducing the pressure in the space comprised between the mobile component 103b and the flexible wall 103c.

The extraction of the fluid via the first and/or second valve makes it possible to reduce the pressure in the hermetic space 104 down to a near vacuum (e.g. below 50 mbar) or, at the very least, below a saturation vapor pressure for water for the prevailing temperature conditions (i.e. conditions inside the hermetic space).

The act of reducing the pressure to below the saturation vapor pressure of water allows moisture present in the air or on the surfaces, notably the surfaces that will be in contact with the hardened adhesive, to “evaporate” off (see below). This depression may be maintained for several minutes or a few seconds (e.g. 20 s) in order to ensure that all of the moisture has disappeared from within the installation device. The atmospheric parameters (such as humidity) can also be checked in order to determine dynamically how long to maintain the depression: as soon as the atmospheric parameters reach predetermined values, the remainder of the installation method may be implemented.

Alternatively, it is possible to circulate a dry gas through the installation device.

Thus, even if the installation device has been installed under extreme conditions (e.g. under water, in the rain, or in a zone with high absolute humidity), it is possible in a simple way to improve the bonding conditions for better mechanical hold and better durability of the bonded assembly.

An adhesive 107 may be present on the surface of the connector 101 situated facing the substrate. This adhesive may have been placed, in the form of a blob of adhesive for example, prior to the installation device being brought into contact with the substrate. Nevertheless, such a technique may limit the size of the bonding zone: specifically, if the blob of adhesive is too large (i.e. with a view to obtaining a large bonding area), it may be difficult to produce a blob that does not have a surface that is locally convex on the surface of the blob of adhesive. If the blob of adhesive has a surface that is locally convex, then an air bubble may form as the adhesive 107 is compressed against the connector 101 and the substrate 102 (see below). In order to alleviate this problem, it is possible to position the connector 101 near the substrate 102 (at a distance that is to be determined experimentally notably according to the rheology of the uncured adhesive) as shown in FIG. 1b, and to inject the uncured adhesive between the connector 101 and the substrate 102 (for example through a hollow screw 110 and an injection device 111 that becomes inserted in said hollow screw): this solution makes it possible to obtain a large bonding area while at the same time limiting the appearance of bubbles in the adhesive. In the embodiment of FIG. 1b, it is possible that movement of the mobile component 103b will be useful in bringing the connector 101 close to the substrate.

The adhesive may also be placed in the form of one or more beads, of multiple blobs or of a film of adhesive over at least part of the surfaces that are to be coated with adhesive.

Once the adhesive is in place (using one of the methods explained hereinabove, for example), it is possible to move the connector 101 toward the substrate 102 by, for example, releasing the catch 108.

This movement may be induced by the difference in pressure there is between the inside of the installation device and the outside of the installation device: if the wall 103c is flexible or movable, it may deform/move against the mobile component 103b and push it toward the substrate.

This movement may also be induced by the difference between the pressure there is in the volume situated between the mobile component 103b and the wall 103c and the pressure there is in the volume situated between the mobile component 103b and the substrate (in the scenario in which these two volumes are sealed relative to each other): the difference in pressure across the mobile component 103b will therefore cause it to move.

Of course, in order to avoid any sudden sharp movement (which may lead to an impact on the substrate) when the catch 108 is released, it is possible to provide braking/partial retention of the component 103b so as to allow a gentle movement.

This movement may make it possible to press the connector 101 against the substrate 102, to compress the adhesive 107 between the connector 101 and the substrate 102 and thus to cause the adhesive 107 to migrate in a centrifugal direction (with respect to a center of the connector): the area of the adhesive located between the connector 101 and the substrate 102 can therefore be enlarged.

FIG. 2a depicts a cross section through a bonded assembly according to one embodiment of the invention.

In this embodiment, a first element 101 of the connector has been bonded to the substrate 102 using the bonding method as described hereinabove, but it should be noted that any other bonding method could have been used.

This bonded assembly comprises the substrate 102 and the connector 101 arranged at a gap to the substrate. Furthermore, a second element 201 of the connector, in the form of a bell, is secured to the first element 101: the nut 203 screws onto the threaded rod or screw 110 in order to immobilize the second element 201 against the first element 101.

In order to ensure a good seal at the contact between the first element 101 and the second element 201, an O-ring seal 204 may be fitted.

The second element 201 extends as far as the substrate in order to make sealed contact between the second element 201 and the substrate 102. This sealed contact is encouraged by the addition of a gasket 202 (for example an O-ring seal) which is compressed between the substrate and the second element. Thus, a sealed volume 206 is then defined by the gasket 202, the second element 201 and the substrate 102: this sealed volume 206 which is set back is an overflow groove and allows excess adhesive to be stored in this space.

The contact between the second element 201 and the substrate 102 (potentially via the gasket 202) is referred to as the support zone. This support zone surrounds the bonding surface of the first element 101 in contact with the adhesive 107.

The second element 201 may be flexible in order to accentuate the force with which the gasket 202 is compressed.

The first element 101 is installed between the second element 201 and the substrate (i.e. inside the sealed volume). The hardened adhesive 107 at least partially occupies the space between the first element 101 and the substrate 102, thus holding the first element on the substrate.

Once they have been assembled, the second element 201 and the gasket 202 protect the adhesive against attack from the external environment while at the same time allowing simplified (e.g. visual) inspection of the adhesive 107 by disconnecting the second element 201 from the first element 101.

Furthermore, the threaded rod or screw 110 provides an interface secured to the bonded assembly and allowing any external structural or mechanical element to be attached.

FIG. 2b depicts a cross section through a bonded assembly according to another embodiment of the invention.

In this embodiment, the second element 201 may be coated with a flexible coating 205 (e.g. bonded elastomer) in order to attenuate the effect of impacts on this second element.

Moreover, this flexible coating 205 may also act as a compressed peripheral gasket 202 if it is extended between the second 201 and the substrate 102.

The coating may be full or partial regarding the second element 201.

The second element 201 may be a plate (as has been depicted in FIG. 2c) or a dome or may have any other shape. A dome shape allows optimum distribution of stresses, whereas a plate makes for ease of manufacture and lower cost.

FIG. 2d depicts a cross section through a bonded assembly according to another embodiment of the invention.

In this embodiment, the presence of a second element is not needed (although that does not in any way exclude there being one).

In this embodiment, the connector 101 is bonded to the substrate 102 using the bonding method described hereinabove, but it should be noted that any other bonding method could have been used.

This bonded assembly comprises the substrate 102 and the connector 101 arranged at a gap to the substrate.

At least one gasket 202 is compressed between the substrate 102 and the peripheral part of the connector 101 (then referred to as the support zone). A sealed volume 209 is then defined by the substrate 102, the connector 101 and the gasket 202.

An overflow groove 208 may be formed inside this volume and at the periphery of the connector bonding surface. This overflow groove 208 is intended to collect the surplus adhesive, as adhesive is generally introduced in excess. This overflow groove may for example be a hollow formed within the material of the connector.

The overflow groove 208 may also act as a fixing groove for attaching the gasket 202. The profile of the overflow groove may be of the fishtail or half-fishtail type, depending on the intended use.

The hardened adhesive 107 can then only partially occupy the sealed volume 209.

FIG. 2e depicts a cross section through a bonded assembly according to another embodiment of the invention.

In this embodiment, the connector 101 can be coated with a flexible coating 210 (e.g. bonded elastomer) in order to attenuate the effect of impacts on the connector.

Furthermore, this flexible coating 210 may likewise act as a compressed peripheral gasket 202 if it is extended between the connector 101 and the substrate 102.

The coating with the flexible coating 210 advantageously does not cover the bonding surface intended to be in contact with the adhesive 107 (or at least in part).

The above embodiments are not mutually exclusive and may be combined.

Moreover, in the above embodiments, the connector 101 may be of circular shape or any other geometric shape. The bonding surface of the connector 101 is generally flat (i.e. on its surface in contact with the adhesive), but may also be of a curved shape, convex or concave, or of any other shape depending on the substrate to which it is to conform (e.g. pressure equipment, boat hull with curved surfaces, piping, etc.). Furthermore, the surface of the main element in contact with the adhesive may deliberately not perfectly complement the surface of the substrate: in order to allow better mechanical performance, it is possible to introduce overthicknesses of adhesive at the places where stresses have a tendency to be concentrated. For example, a slight hollow in the middle of the bonding surface in contact with the adhesive may be introduced so as to generate a greater thickness of adhesive in the central zone, thus reducing the stress concentrations initially observed at this point through the additional flexibility it affords. Similarly, a profile shape that widens in the output direction on the edges will have a tendency to increase the thickness of adhesive at the periphery, and this will have the effect of lessening the edge effects.

The bonded assembly (and notably the size of the bonded surface) may be dimensioned in such a way that the capability of the threaded rod or screw 110 is reached before that of the adhesive interface. Thus, the interface or screw 110 has a mechanical breaking strength that is lower than a mechanical yield strength of the adhesion of said connector to the substrate using the hardened adhesive. If necessary, a striction may be introduced at the base of the threaded rod or screw 110 in order to act as a “weak link” if necessary. This reduced strength makes it possible to prevent the adhesive interface, which is complex to produce, from being damaged in the event of potential pull-out. It is easier to replace the threaded rod or screw 110.

It is also possible to provide screws in the connector 101. These screws are not used during the normal use of the bonded assembly. Nevertheless, when there is a need to “unglue” the assembly, these screws (which pass through the connector in the direction of the substrate) can be screwed down and apply a force in the direction of these screws pressing against the substrate in order to detach the connector 101 from the substrate 102.

Of course, the present invention is not restricted to the forms of embodiment described hereinabove by way of example: it extends to other alternative forms.

1. A bonded assembly, said assembly comprising:
a substrate (102);
a connector (101, 201) comprising:
a bonding surface arranged with a gap to the substrate (102);
a support zone surrounding said bonding surface;
at least one gasket (202) compressed between the substrate and the support zone, said gasket (202), the connector (101, 201) and the substrate (102) delimiting a sealed volume (209);
a recessed overflow groove (208) formed between the bonding surface and the support zone and forming part of the sealed volume (209); and
a hardened adhesive (107) at least partially occupying said sealed volume, the adhesive holding the connector on the substrate via the bonding surface.

2. The assembly as claimed in claim 1, in which the connector comprises a first element (101) and a second element (201), the second element (201) being secured to the first element.

3. The assembly as claimed in claim 1, in which the connector comprises an interface for attaching an external element and in which the interface has a mechanical breaking strength that is lower than a mechanical breaking strength of the hardened adhesive.

4. The assembly as claimed in claim 1, in which the connector is partially coated in a flexible coating (210), the bonding surface not being coated.

5. The assembly as claimed in claim 4, in which the at least one gasket (202) is formed by said flexible coating (210).

6. The assembly as claimed in claim 1, in which the connector (101) comprises a one-piece component comprising the bonding surface and the support zone, the overflow groove being formed in the one-piece component.

7. A method for bonding a connector (101, 201) to a substrate (102), comprising:
bringing an installation device (103a, 103b, 103c) into contact with the substrate (102) in such a way that the installation device and the substrate delimit a hermetic space (104), said connector (101, 201) being installed in said hermetic space and arranged with a gap (105) to the substrate;
reducing the pressure (106a, 106b) within said hermetic space; and
moving the connector (101) toward the substrate (102) to compress an adhesive (107) between the substrate and the connector.

8. The bonding method as claimed in claim 7, in which the reduction in pressure leads to a pressure within said hermetic space that is below a saturation vapor pressure of water or below 900 mbar.

9. The bonding method as claimed in claim 7, in which a movement of at least one surface (103c) of the installation device (103a, 103b, 103c) under the effect of a pressure difference contributes to the moving of the connector (101).

10. The bonding method as claimed in claim 7, in which a time difference between the reduction in pressure and the moving of the connector is longer than 20 s.

11. The bonding method as claimed in claim 7, in which the moving of the connector is performed if at least one condition relating to a moisture content inside the hermetic volume (104) is met.

12. The bonding method as claimed in claim 7, in which the method further comprises a braking of the connector during the movement toward the substrate.

13. The bonding method as claimed in claim 7, in which the method further comprises injecting the adhesive after the reduction in pressure.

14. The bonding method as claimed in claim 7, in which the method further comprises:
emptying a liquid contained in said hermetic space (104);
rinsing said hermetic space (104); and
dehydrating said hermetic space (104).

15. The bonding method as claimed in claim 7, in which the method further comprises:
keeping the connector (101) in compression on the substrate while the adhesive hardens.

16. The bonding method as claimed in claim 7, in which the method further comprises:
maintaining said connector (101) at a temperature below 0° C., the adhesive being applied to said connector (101) during the temperature-maintaining period, and
warming said adhesive before a hardening of said adhesive.
